(19) United States
(12) Patent Application Publication
(10) Pub. No.: US 2016/0171556 A1
(43) Pub. Date: Jun. 16, 2016

(54) SYSTEMS AND METHODS FOR NOTIFYING A USER OF LIFE EVENTS EXPERIENCED BY CONTACTS OF THE USER

(71) Applicant: Michael John Grewe, Clarkson Valley, MO (US)

(72) Inventor: Michael John Grewe, Clarkson Valley, MO (US)

(21) Appl. No.: 14/970,640

(22) Filed: Dec. 16, 2015

Related U.S. Application Data
(60) Provisional application No. 62/092,668, filed on Dec. 16, 2014.

(51) Int. Cl. G06Q 30/02; G06Q 50/00; G06F 3/0484

(52) U.S. Cl. CPC G06Q 30/0269; G06F 3/04842; G06Q 30/0267; G06Q 50/01

(57) ABSTRACT

A computer-implemented method for notifying a user of life events experienced by contacts of the user includes receiving at least one user contact name, wherein each user contact name is retrieved from at least one of an email account, a social network account, and a mobile device. The method also includes receiving at least one selected publication and receiving event data, wherein the event data is associated with the at least one selected publication. The method further includes automatically searching the event data for at least one matching occurrence of the at least one user contact name and identifying a portion of the event data that includes a first matching occurrence. The method further includes transmitting the portion of event data to the mobile device and transmitting online content to the mobile device, wherein the online content is associated with a product available for purchase.

### CROSS-REFERENCE TO RELATED APPLICATION

This application claims priority to U.S. Provisional Application No. 62/092,668, filed Dec. 16, 2014, the disclosure of which is hereby incorporated by reference in its entirety.

### FIELD

The field of the disclosure relates generally to the use of client applications or apps, and more particularly, to notifying a user of life events experienced by contacts of the user, using an event notice application.

### BACKGROUND

Generally, it is very difficult for one to remain aware of important events occurring in the lives of one's contacts. Even having the best, most determined intentions, one is bound to miss important dates and events, which can be frustrating at best, if an opportunity is missed to congratulate a friend about her child's accomplishment, and can be devastating at worst, if a memorial service for a relative or close friend is missed. In cases where such information may be available, it can be frustrating and time consuming to try to search for the information. Moreover, response to, or attendance at, such events can be time-sensitive, thus prompt knowledge of such events is needed. In some cases, information regarding these life events can be very difficult to obtain. Different publications may provide the information, but due to formatting or access concerns, the information may be difficult to obtain or be obscured. Moreover, information may be contained in and scattered across multiple news sources, social media and the like. A more reliable system that provides information about life events in an accessible, prompt, and concise manner is needed.

### BRIEF DESCRIPTION

In one aspect, a computer-implemented method for notifying a user of life events experienced by contacts of the user is implemented using a notification server in communication with a memory. The method includes receiving, by the notification server, at least one user contact name, wherein each user contact name is retrieved from at least one of an email account, a social network account, and a mobile device associated with the user, and wherein each user contact name is associated with a user contact of the user. The method also includes receiving at least one selected publication from the user, and receiving event data, wherein the event data is associated with the at least one selected publication. The method further includes automatically searching, by the notification server, the event data for at least one matching occurrence of the at least one user contact name. The method also includes identifying a portion of the event data that includes a first matching occurrence of a first user contact name of the at least one user contact name, wherein the portion of event data includes a life event experienced by a first user contact associated with the first user contact name. The method still further includes transmitting the portion of event data to the mobile device for display to the user within a user interface of an event notice app, and transmitting online content to the mobile device for display to the user within the user interface of the event notice app, wherein the online content is associated with a product available for purchase by the user, the product being associated with the life event experienced by the first user contact.

In another aspect, a computer-readable media having computer-executable instructions embodied thereon for notifying a user of life events experienced by contacts of the user, within a user interface of an event notice app, is provided. When executed by a computer having at least one processor, the computer-executable instructions cause the processor to receive at least one user contact name, wherein each user contact name is retrieved from at least one of an email account, a social network account, and a mobile device associated with the user, and wherein each user contact name is associated with a user contact of the user. When executed by a computer having at least one processor, the computer-executable instructions also cause the processor to receive at least one selected publication from the user, and to receive event data, wherein the event data is associated with the at least one selected publication. When executed by a computer having at least one processor, the computer-executable instructions also cause the processor to automatically search the event data for at least one matching occurrence of the at least one user contact name, and to identify a portion of the event data that includes a first matching occurrence of a first user contact name of the at least one user contact name, wherein the portion of event data includes a life event experienced by a first user contact associated with the first user contact name. When executed by a computer having at least one processor, the computer-executable instructions still further cause the processor to transmit the portion of the event data to the mobile device for display to the user, and to transmit online content to the mobile device for display to the user, wherein the online content is associated with a product available for purchase by the user, the product being associated with the life event experienced by the first user contact.

In yet another aspect, an event notice computer system for notifying a user of life events experienced by contacts of the user includes a notification server including a processor in communication with a memory. The processor is programmed to receive at least one user contact name, wherein each user contact name is retrieved from at least one of an email account, a social network account, and a mobile device associated with the user, and wherein each user contact name is associated with a user contact of the user. The processor is also programmed to receive at least one selected publication from the user, receive event data, wherein the event data is associated with the at least one selected publication, and automatically search the event data for at least one matching occurrence of the at least one user contact name. The processor is further programmed to identify a portion of the event data that includes a first matching occurrence of a first user contact name of the at least one user contact name, wherein the portion of event data includes a life event experienced by a first user contact associated with the first user contact name, transmit the portion of event data to the mobile device for display to the user, and transmit online content to the mobile device for display to the user, wherein the online content is associated with a product available for purchase by the user, the product being associated with the life event experienced by the first user contact.

Various refinements exist of the features noted in relation to the above-mentioned aspects. Further features may also be incorporated in the above-mentioned aspects as well. These refinements and additional features may exist individually or in any combination. For instance, various features discussed below in relation to any of the illustrated embodiments may be incorporated into any of the above-described aspects, alone or in any combination.

### BRIEF DESCRIPTION OF THE DRAWINGS

FIGS. 1-14 show example embodiments of the methods and systems described herein.

FIG. 1 is a simplified block diagram of an example event notice system for providing notice of life events of a user's contacts.

FIG. 2 is a more detailed block diagram of the example event notice system shown in FIG. 1.

FIG. 3 illustrates an example configuration of a mobile device shown in FIG. 1.

FIG. 4 illustrates an example configuration of a server system shown in FIG. 1.

FIG. 5 is a diagram illustrating the flow of data within the event notice system shown in FIG. 1.

FIG. 6 shows an example embodiment of a client application store and an event notice app download interface.

FIG. 7 shows an example embodiment of a mobile device home screen including an event notice app icon.

FIG. 8 shows an example embodiment of an event notice app user interface (UI) displaying a start screen.

FIG. 9 shows an example embodiment of an event notice app UI displaying a sign-up screen.

FIGS. 10A-10D show example embodiments of an event notice app UI displaying various selected publication screens.

FIG. 11 shows an example embodiment of a mobile device UI displaying a contact retrieval authorization dialog box.

FIGS. 12A-12E show example embodiments of an event notice app UI displaying various search result screens.

FIG. 13 shows an example embodiment of an event notice app UI displaying a matching occurrence.

FIG. 14 shows an example embodiment of a linked advertiser app UI, accessed through an event notice app.

Like reference numerals in the Figures indicate the same or functionally similar components.

### DETAILED DESCRIPTION

The event notice system described herein is configured to provide notice of life events of a user's contacts to the user using an event notice client application (the “event notice app”). The event notice system includes a notification server and at least one mobile device operated by an associated user. The notification server includes server architecture configured to enable the event notice app to function on the mobile device. Generally, the user downloads the event notice app (using the mobile device) and authorizes the event notice app to retrieve “user contact names,” or the names associated with each of the user's contacts. The user contact names may be retrieved from at least one of the user's email account, social media account, or mobile device. The notification server receives and stores user contact names. The notification server may receive and store additional contact information associated with each user contact name. The user uses the event notice app to select at least one publication in which the user would like the event notice app to search for matching occurrences of each user contact name. The notification server receives and stores the selected publications. The notification server further receives event data associated with the selected publications. The notification server then searches the event data for any matching occurrence(s) of the user contact name. The notification server returns the matching occurrence(s) to the event notice app for display to the user.

As used herein, “matching occurrence” is used generally to refer to a result returned by the notification server that is determined to contain a user contact name and/or additional user contact information. In some embodiments, these results need not be limited to a full match and may include partial matches, contextual matches (e.g., “Joe” as a match for “Joseph”), pattern matching, and/or be the result of a social graph analysis. Social graph analysis refers to the analysis of relationships between users over various social media, including contacts and/or behavior users have in common (e.g., “mutual friends”), as well as mining social media for user details for comparison and/or other processing (e.g., hometowns, educational institutions, workplaces, etc.). Additionally, for example, “matching occurrence” may refer to results obtained using not only searching but any predictive analytic algorithm or technique, including machine learning, Levenshtein distance algorithms, Soundex techniques, full text searching, and any other algorithm or technique. As such, the term “matching occurrence” and the term “search” are used in a general and not a limiting sense.

In an example embodiment, the user requests and receives matching occurrences from within a user interface of the event notice app. For example, the user receives a notification on the mobile device (e.g., an email or a “push notification”) that the event notice app has received at least one new matching occurrence. The user may then access the event notice app and view the matching occurrence(s). In some embodiments, the matching occurrences include text and/or images (and/or other digital content) surrounding the user contact name. For example, a matching occurrence may include an obituary or death announcement that includes a user contact name.

The event notice app further includes online content that is displayed to the user. The online content includes at least one product available for purchase by the user. The online content may enable the user to purchase the produce within a user interface of the event notice app. In some embodiments, the online content includes advertising space. The advertising space may include advertisements that are delivered to the event notice app based on the content of the matching occurrence(s). For example, the event notice app may display an advertisement for sympathy flowers if the matching occurrence includes an obituary or death announcement. The advertisement may further include a link to an associated advertiser's website or to the associated advertiser's own client application on the mobile device.

In some embodiments, the online content includes purchasing space. The purchasing space displays various products (e.g., flowers and cards) that the user may select and purchase within the event notice app, without being directed to a third-party app or website. As used herein, “products” refers generally to goods and/or services available for purchase by the user.

At least one of the technical problems addressed by this system includes: (i) delayed or lack of knowledge of life events of a person's contacts; (ii) difficulty searching for and within publications that may include information about the contacts; and (iii) inconvenience purchasing and sending gifts of congratulations or sympathy in reaction to notification of a contact's life event.

The technical effect of the disclosure is achieved by performing at least one of the following steps: (i) receiving, by the notification server, at least one user contact name, wherein each user contact name is retrieved from at least one of an email account, a social network account, and a mobile device associated with the user, and wherein each user contact name is associated with a user contact of the user; (ii) receiving at least one selected publication from the user; (iii) (iv) receiving event data, wherein the event data is associated with the at least one selected publication; (v) automatically searching, by the notification server, the event data for at least one matching occurrence of the at least one user contact name; (vi) identifying a portion of the event data that includes a first matching occurrence of a first user contact name of the at least one user contact name, wherein the portion of event data includes a life event experienced by a first user contact associated with the first user contact name; (vii) transmitting the portion of event data to the mobile device for display to the user within a user interface of an event notice app; and (viii) transmitting online content to the mobile device for display to the user within the user interface of the event notice app, wherein the online content is associated with a product available for purchase by the user, the product being associated with the life event experienced by the first user contact.

The technical effect achieved by the system is at least one of: (i) prompt notifications of life events related to one's contacts; (ii) simplified and concise presentations of such notifications; and (iii) convenient access to gifts, cards, and other messages of condolence, sympathy, and congratulations.

The following detailed description illustrates embodiments of the disclosure by way of example and not by way of limitation. It is contemplated that the disclosure has general application to mobile device applications.

As used herein, the term “database” may refer to either a body of data, a relational database management system (RDBMS), to both, or to a non-relational data store systems such as NoSQL databases, Hadoop Distributed File System (HDFS), and Azure Storage. As used herein, a database may include any collection of data including hierarchical databases, relational databases, flat file databases, object-relational databases, object oriented databases, and any other structured collection of records or data that is stored in a computer system. The above examples are example only, and thus are not intended to limit in any way the definition and/or meaning of the term database. Examples of RDBMS's include, but are not limited to including, Oracle® Database, MySQL, IBM® DB2, Microsoft® SQL Server, Sybase®, and PostgreSQL. However, any database may be used that enables the systems and methods described herein. (Oracle is a registered trademark of Oracle Corporation, Redwood Shores, Calif.; IBM is a registered trademark of International Business Machines Corporation, Armonk, N.Y.; Microsoft is a registered trademark of Microsoft Corporation, Redmond, Wash.; and Sybase is a registered trademark of Sybase, Dublin, Calif.)

In one embodiment, a computer program is provided, and the program is embodied on a computer readable medium. In an example embodiment, the system is executed on a single computer system, without requiring a connection to a server computer. In a further embodiment, the system is being run in a Windows® environment (Windows is a registered trademark of Microsoft Corporation, Redmond, Wash.). In yet another embodiment, the system is run on a mainframe environment and a UNIX® server environment (UNIX is a registered trademark of X/Open Company Limited located in Reading, Berkshire, United Kingdom). The application is flexible and designed to run in various different environments without compromising any major functionality. In some embodiments, the system includes multiple components distributed among a plurality of computing devices. One or more components may be in the form of computer-executable instructions embodied in a computer-readable medium.

As used herein, an element or step recited in the singular and proceeded with the word “a” or “an” should be understood as not excluding plural elements or steps, unless such exclusion is explicitly recited. Furthermore, references to “one embodiment” of the present disclosure are not intended to be interpreted as excluding the existence of additional embodiments that also incorporate the recited features.

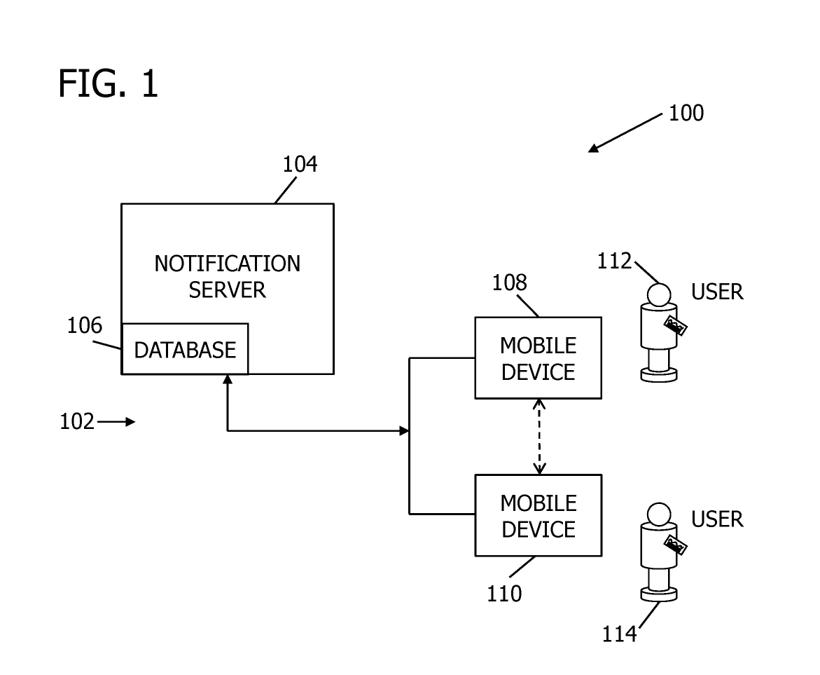

Referring now to the figures, FIG. 1 is a block diagram of an example system 100 including a server system 102 that includes a notification server 104 and mobile devices 108, 110 operated by users 112, 114. In the example embodiments, system 100 is used to provide notice to a user 112, 114 of life events of the user's 112, 114 contacts, using the event notice app accessible using mobile device 108, 110. As used herein, “notification server” refers generally to server architecture utilized to enable event notice applications or software to function on mobile devices 108, 110. As used herein, “application” or “app” refers to a self-contained program or piece of software designed to fulfill a particular purpose and downloaded by one of users 112, 114 to the respective mobile device 108, 110.

More specifically, in the example embodiment, mobile devices 108, 110 are in communication with notification server 104. Mobile devices 108, 110 are associated with users 112, 114 and are used to host the event notice app, which the users 112, 114 use to communicate with notification server 104. As used herein, “mobile device” could be any device capable of interconnecting to the Internet, including but not limited to, smart phones, cell phones, tablets, “phablets,” PDAs, personal computers, laptops, netbooks, or other web-based connectable equipment. Mobile devices 108, 110 are interconnected to the Internet through many interfaces, such as a local area network (LAN) or a wide area network (WAN), dial-in-connections, cable modems, special high-speed Integrated Services Digital Network (ISDN) lines, and RDT networks.

A database 106 is connected to notification server 104, which contains information on a variety of matters, as described below in greater detail. In one embodiment, centralized database 106 is stored on notification server 104 and can be accessed by users 112, 114 at one of mobile devices 108, 110 by logging onto notification server 104 through one of mobile devices 108, 110. In an alternative embodiment, database 106 is stored remotely from notification server 104 and may be non-centralized.

Database 106 may include a single database having separated sections or partitions, or may include multiple databases, each being separate from each other. Database 106 may store selected publication(s) that have been selected by a user 112, 114 using the event notice app on a mobile device 108, 110. Database 106 may also store event data received by notification server 104 that is filtered by the selected publication(s). Database 106 may also store user contact name(s) of contact(s) associated with a user 112, 114 and/or the user's email account, social network account, and/or mobile device 108, 110. Database 106 may also store matching occurrences retrieved by notification server 104 during searching.

Generally, notification server 104 receives the selected publications (e.g., the name of a newspaper or periodical) from the user. The user may input, or select from a list of publications, those publications that the user would like the event notice app to search within for the name(s) of the user's contact(s). Notification server 104 then retrieves the event data associated with the user's selected publications. Notification server 104 may receive event data from at least one third party source. “Event data” is used herein to refer generally to raw (unpublished) event data from a third party that may be sent to publications to be published and to unpublished or published data received directly from publications. For example, event data may include obituary information, wedding announcements, and/or birth announcements that is collected by a third-party source and then sent to periodicals or newspapers to be published. In some embodiments, event data may be received and/or filtered through an XML feed from the at least one third party source. In other embodiments, event data may be received and/or filtered through an application programming interface (API) platform hosted by the third party source or event notice system 100. At least some of these third-party sources may be under contract with notification server 104 (or a party responsible for maintaining or otherwise associated with notification server 104) to provide event data thereto. In some embodiments, notification server 104 receives event data and filters the received event data based on the selected publications. In other words, notification server preferentially stores event data that is sent to or associated with at least one selected publication. In some embodiments, notification server 104 receives “pre-filtered” event data. In other words, a separate filtering component (not shown) of event notice system 100 and/or a filtering component associated with the third-party source filters the event data before is received by notification server 104.

Notification server 104 searches the event data for any matching occurrence of a user contact name. The user contact name may be a last name of an associated contact or both a first and last name of the associated contact. For example, notification server 104 may be configured to search the event data for any matching occurrence of the last name(s) of a user's contact(s) and return any matching occurrence(s) to the event notice app for display to the user 112, 114.

In some embodiments, information may be collected, stored, analyzed, and/or otherwise used by the event notice system 100. For example, a history of searches and/or matching occurrence(s), a history of user interaction with and behavior within the event notice app, and any other information may be stored and analyzed by event notice system 100.

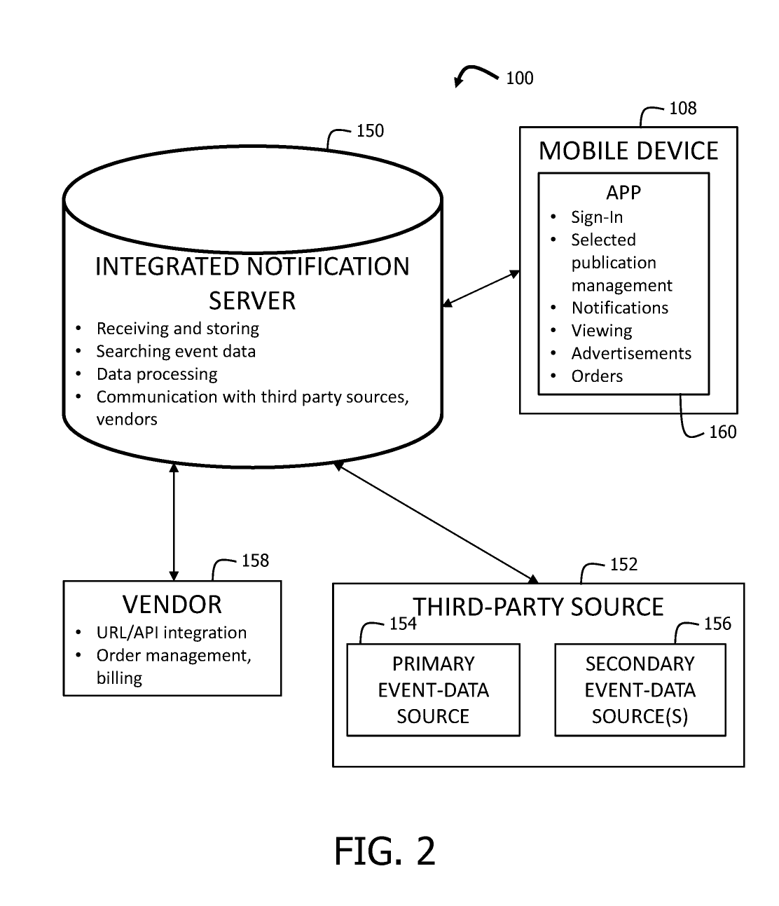

FIG. 2 is a more detailed block diagram of event notice system 100 (shown in FIG. 1). In the example embodiment, event notice system 100 includes an integrated notification server 104 and database 106 (both shown in FIG. 1), herein referred to as integrated notification server 150. Any reference herein to notification server 104 and/or database 106 may also refer to integrated notification server 150. Event notice system 100 also includes mobile device 108 (shown in FIG. 1), which is in communication with integrated notification server 150. Event notice system 100 further includes third-party sources 152 of event data. In the example embodiment, third-party sources 152 include a primary event data source 154 and secondary event data sources 156. Although FIG. 2 illustrates only one secondary event data source 156, event notice system 100 may include any number of secondary event data sources 156 and operate as described herein. Third-party sources 152 are in communication with integrated notification server 150. Event notice system 100 further includes vendor 158, which is in communication with integrated notification server 150. Although FIG. 2 illustrates only one vendor 158, event notice system 100 may include any number of vendors 158 and operate as described herein.

In the example embodiment, integrated notification server 150 is configured to receive and/or process user contact names, selected publications, and/or event data. Integrated notification server 150 may receive event data from third-party sources 152. Integrated notification server 150 may receive user contact names and selected publications from mobile device 108. Integrated notification server 150 may be further configured to filter received event data such that the filtered event data is associated with the selected publications. Event data may be filtered to be associated with the selected publications before it is received by integrated notification server 150.

Integrated notification server 150 is further configured to search the event data for matching occurrence(s) of the user contact name(s) and to identify a portion of the event data that includes a matching occurrence of any user contact name. The portion of the event data is associated with at least one of the selected publications. For example, the portion of the event data may be published in at least one of the selected publications. Integrated notification server 150 is further configured to transmit each identified portion of the event data to mobile device 108 for display to the user. Integrated notification server 150 may transmit the event data to mobile device 108 in an activation signal configured to activate mobile device 108 to display the event data to the user on a display or UI (“display feature”) of mobile device 108. Further, the portion of the event data is related to or associated with a life event experienced by a user contact associated with the user contact name found in the matching occurrence.

Mobile device 108 is configured to download and launch an event notice app 160. Event notice app 160 is configured to enable, for example, sign-in by the user, management of the user's selected publications, notification and viewing of search results, viewing of advertisements, and purchasing/ordering of product(s) from within a user interface (UI) of event notice app 160.

Third-party sources 152 may provide event data to integrated notification server 150. In the example embodiments, third-party sources include primary event data source 154. Primary event data source 154 is contracted to provide event data, such as obituaries or other announcements, to publications (e.g., the selected publications) and to the integrated notification server 150. The event data may be published in the publications. For example, a primary event data source 154 may provide obituaries from funeral homes to newspapers or other periodicals. The event data includes information about an associated event (e.g., death, funeral, wedding, birth) and an associated subject of the event. Secondary event data sources 156 include, for example, social media sites which may host and provide “unofficial” event data. For example, a person may post a personal status or message about the death of a relative or colleague. This event data may also be provided to integrated notification server 150.

Vendor 158 may include, for example, an advertiser or any other vendor of goods and/or services. Integrated notification server 150 may be configured to provide advertisement and/or purchasing space to the user, using a user interface of an event notice app on mobile device 108. Advertising space may be purchased by an advertiser (e.g., vendor 158). Purchasing space may display, within the event notice app, various products available for purchase by the user. Integrated notification server 150 may communicate with vendor 158 to, for example, manage content of the advertising and/or purchasing space and to manage purchases or orders made using the advertising and/or purchasing space. Integrated notification server 150 may communicate with vendor 158 using, for example, URL integration (to communicate with multiple vendors substantially simultaneously) or API integration (to communication with a particular vendor). For example, in some embodiments, integrated notification server 150 may collect data input by a user during a purchase or order made within a user interface of event notice app 160 (e.g., billing information, shipping address, product purchased). Integrated notification server 150 may then transmit that purchase data to vendor 158 for managing the purchase and fulfilling the order. In other embodiments, integrated notification server 150 may store an indication that a user of mobile device 108 has selected an advertisement (e.g., may store a “click-through” indication), which navigates the user of mobile device 108 to a vendor website or app to view and/or purchases products directly from vendor 158. Additionally, integrated notification server 150 may receive a notification from vendor 158 each time a user subsequently makes a purchase from vendor 158 after “clicking-through” (known as a “conversion”). Click-throughs and conversions may be used to generate revenue for a party associated with integrated notification server 150 from vendor 158.

In some embodiments, integrated notification server 150 is configured to transmit leads to vendor 158. For example, integrated notification server 150 may record which users of event notice system 100 receive search results related to particular events, such as death notices or birth announcements. Integrated notification server 150 may then transmit collected, anonymized, and/or aggregated information about such users—leads—to vendor 158. Vendor 158 may use the transmitted leads to transmit content, such as advertisements, to those users based on the particular event. In such embodiments, users are given the opportunity to allow or disallow the recordation and/or transmittal of such information to vendors 158.

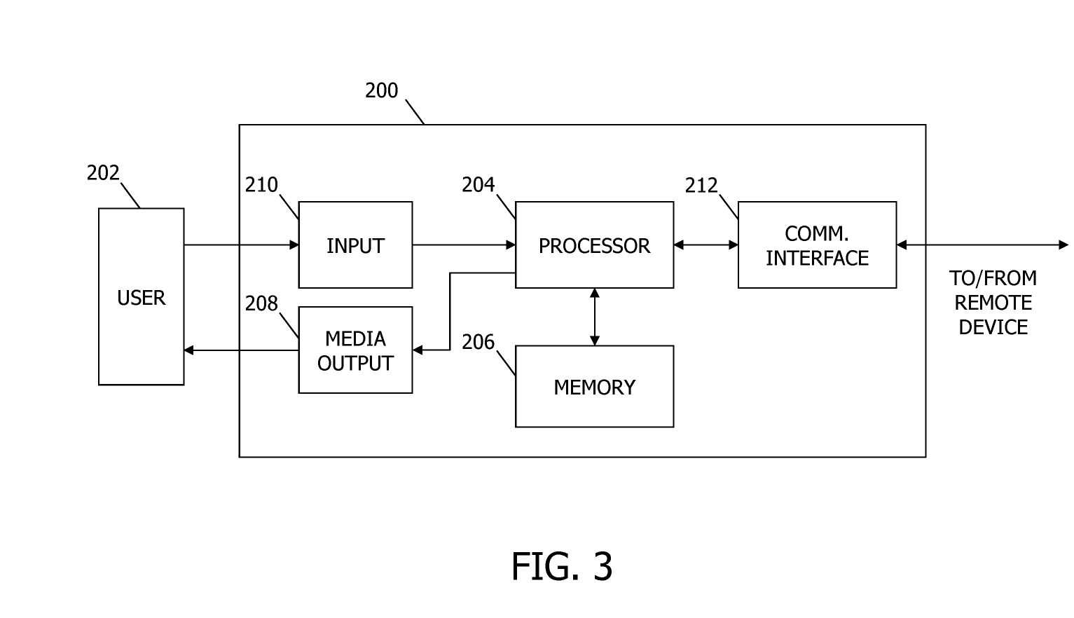

FIG. 3 illustrates an example configuration of a mobile device 300, such as mobile devices 108, 110, operated by a user 302, such as users 112, 114. Mobile device 300 may include any of mobile devices 108, 110, any suitable mobile device, and any other computing device configured to operate as described herein. Mobile device 300 includes a processor 304 for executing instructions. In some embodiments, executable instructions are stored in a memory area 306. Processor 304 may include one or more processing units (e.g., in a multi-core configuration). Memory area 306 is any device allowing information such as executable instructions and/or written works to be stored and retrieved. Memory area 306 may include one or more computer readable media.

Mobile device 300 also includes at least one media output component 308 for presenting information to user 302. Media output component 308 is any component capable of conveying information to user 302. In some embodiments, media output component 308 includes an output adapter such as a video adapter and/or an audio adapter. An output adapter is operatively coupled to processor 304 and operatively couplable to an output device such as a display feature or display device (e.g., a liquid crystal display (LCD), organic light emitting diode (OLED) display, or “electronic ink” display) or an audio output device (e.g., a speaker or headphones).

In some embodiments, mobile device 300 includes an input device 310 for receiving input from user 302. Input device 310 may include, for example, a keyboard, a pointing device, a mouse, a stylus, a touch sensitive panel (e.g., a touch pad or a touch screen), a gyroscope, an accelerometer, a position detector (e.g., a global positioning system (GPS)), or an audio input device. A single component such as a touch screen may function as both an output device of media output component 308 and input device 310.

Mobile device 300 may also include a communication interface 312, which is communicatively couplable to a remote device such as notification server 104 (shown in FIG. 1). Communication interface 312 may include, for example, a wired or wireless network adapter or a wireless data transceiver for use with a mobile phone network (e.g., Global System for Mobile communications (GSM), 3G, 4G, 4G Long-Term Evolution (LTE), XLTE, Universal Mobile Telecommunications Systems (UMTS)) or other mobile data network (e.g., Worldwide Interoperability for Microwave Access (WIMAX), Time Division Multiple Access (TDMA), Code Division Multiple Access (CDMA), CDMA2000, Enhanced Data rates for Global Evolution (EDGE), Enhanced Voice-Data Optimized (EVDO)).

Stored in memory area 306 are, for example, computer readable instructions for providing a user interface to user 302 via media output component 308 and, optionally, receiving and processing input from input device 310. A user interface may include, among other possibilities, a web browser and a client application. Web browsers enable users, such as user 302, to display and interact with media and other information typically embedded on a web page or a website. A client application allows user 302 to interact with a server application from, for example, notification server 104.

Mobile device 300 is configured to launch an event notice app by receiving input from user 302 at media input 310, which executes the event notice app on the media output 308. Further, the event notice app enables the retrieval of user contact names from at least one of an email account, a social network account, or mobile device 300 associated with user 302. The event notice app further enables the display of matching occurrences of user contact name(s) to user 302 using media output 308.

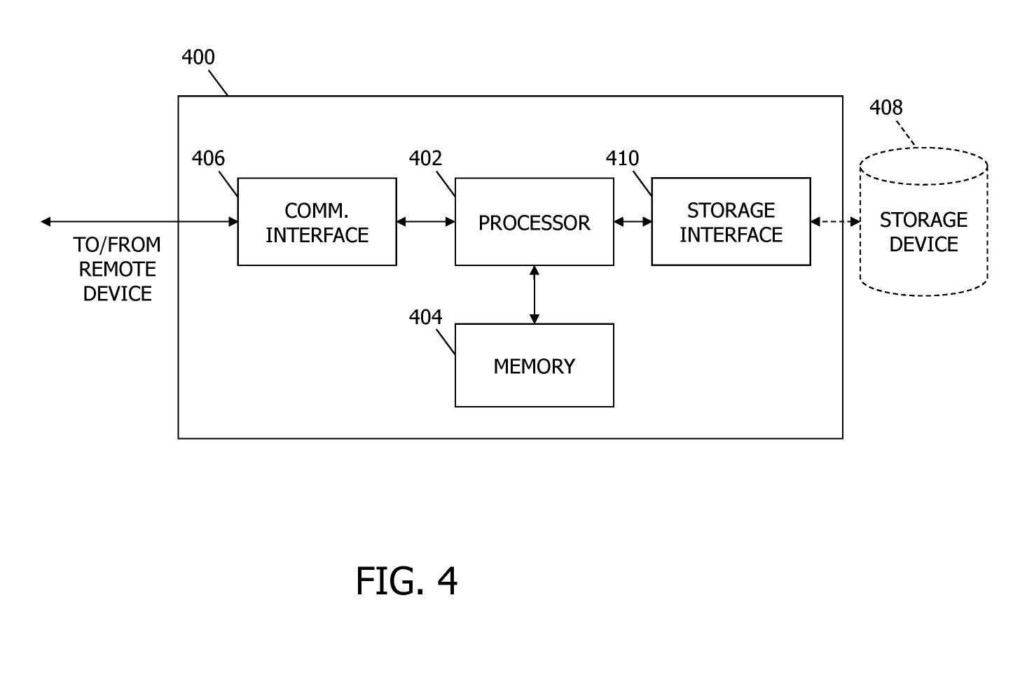

FIG. 4 illustrates an example configuration of a server computing device 400 such as notification server 104 (shown in FIG. 1). Server computing device 400 includes a processor 402 for executing instructions. Instructions may be stored in a memory area 404, for example. Processor 402 may include one or more processing units (e.g., in a multicore configuration). Processor 402 is operatively coupled to a communication interface 406 such that server computing device 400 is capable of communicating with a remote device such as mobile device 300 (shown in FIG. 3) or another server computing device 400. For example, communication interface 406 may receive requests from mobile device 300 via the Internet.

Processor 402 may also be operatively coupled to storage device 408. Storage device 408 is any computer-operated hardware suitable for storing and/or retrieving data. In some embodiments, storage device 408 is integrated in server computing device 400. For example, server computing device 400 may include one or more hard disk drives as storage device 408. In other embodiments, storage device 408 is external to server computing device 400 and may be accessed by a plurality of server computing devices 400. For example, storage device 408 may include multiple storage units such as hard disks or solid state disks in a redundant array of inexpensive disks (RAID) configuration. Storage device 408 may include a storage area network (SAN), a network attached storage (NAS) system, and/or a direct attached storage (DAS) system.

In some embodiments, processor 402 is operatively coupled to storage device 408 via a storage interface 410. Storage interface 410 is any component capable of providing processor 402 with access to storage device 408. Storage interface 410 may include, for example, an Advanced Technology Attachment (ATA) adapter, a Serial ATA (SATA) adapter, a Small Computer System Interface (SCSI) adapter, a Serial Attached SCSI (SAS), a fiber channel, a RAID controller, a SAN adapter, a network adapter, and/or any component providing processor 402 with access to storage device 408.

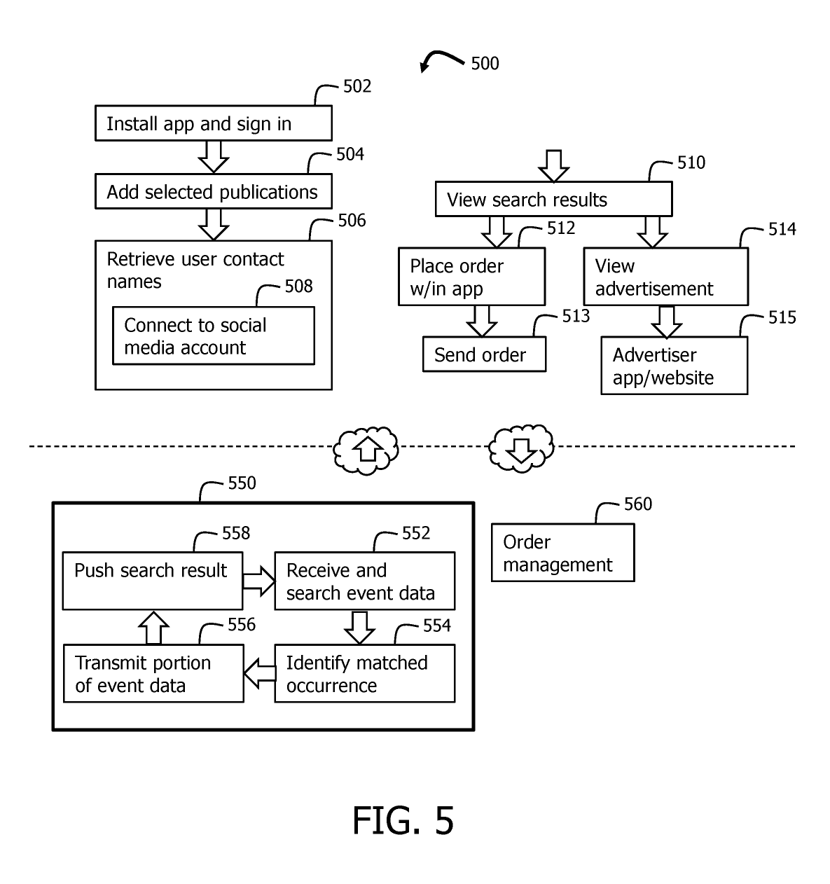

FIG. 5 is a diagram illustrating the flow 500 of data within event notice system 100 (shown in FIG. 1). Generally, the steps or processes shown above the dotted line are performed at or using a mobile device (e.g., mobile device 108, 110, shown in FIG. 1). The steps or processes shown below the dotted line are performed at or using integrated notification server 150 (shown in FIG. 2). More particularly, at step 502, a user installs an event notice app on the mobile device and signs in to the event notice app. At step 504, the user selects at least one selected publication. The selected publications define the event data that integrated notification server 150 will search; integrated notification server 150 filters event data associated with the selected publications. At step 506, the user authorizes the event notice app to retrieve user contact names of contacts associated with the user. Optionally, indicated by step 508, user contact names and additional contact information may be retrieved from social media accounts associated with the user,

Processes 550 performed outside of the mobile device are generally performed after the necessary inputs (selected publication, user contact names) are received from the user. Processes 550 includes receiving and searching 552 event data; identifying 554 matching occurrences of user contact names in the event data; transmitting 556 the portions of the event data including the matching occurrences to the event notice app on the mobile device (e.g., in an activation signal configured to activate the mobile device to display the event data); and pushing 558 new/unread search results including the portions of the event data to the user.

Subsequently, at step 510, the user may view the search results and read the portions of the event data. In response to step 510, the user may purchase a product from within the event notice app at step 512. Orders made within the event notice app may be sent, at step 513, to one or more vendors for fulfillment. Particular order management is performed by integrated notification server 150 and vendor(s) 158 (shown in FIG. 2), at step 560. The user may additionally or alternatively, at step 514, view advertisements associated with one or more linked advertisers, wherein the advertisement enable the user to make a purchase. Advertisements may, indicated by step 515, require the user to use the linked advertiser's app or website to complete the order or purchase. As described above, a record of the user selecting or “clicking-through” an advertisement and/or of a “conversion” (a user subsequently making a purchase on the linked advertiser's app or website) may be stored.

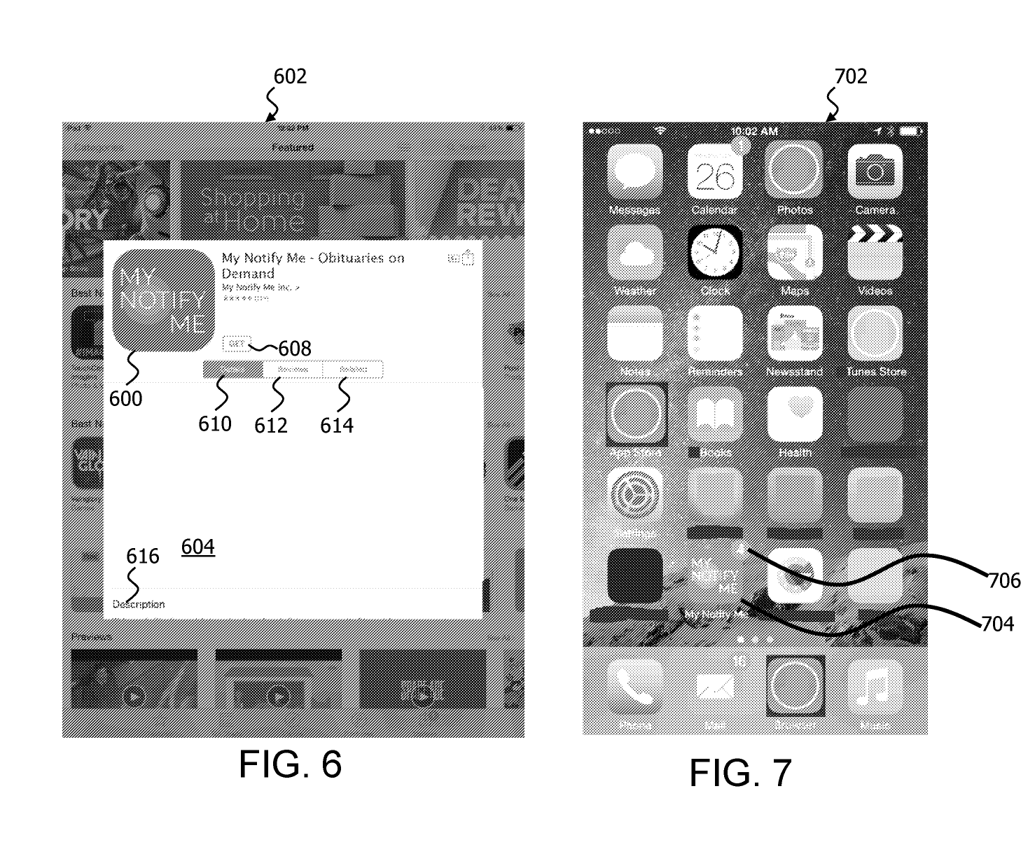

FIG. 6 shows an example embodiment of a client application store (“app store”) 602 and an event notice app download interface 604. App store 602 allows a user (e.g., user 112, 114, shown in FIG. 1) to find and purchase and/or download apps onto his or her mobile device. Download interface 604 is displayed upon selection by the user of the event notice app 600 within app store 602. In the example embodiment, download interface 604 includes a purchase and/or download option 608. The user may select this option 608 to initiate a download of the event notice app 600 onto the user's mobile device (e.g., mobile device 108, 110, shown in FIG. 1). Notification server 104 (shown in FIG. 1) is configured to enable transfer of event notice app 600 software to the mobile device of the user. Download interface 604 may also include a “Details” option 610, a “Reviews” option 612, a “Related” option 614, and any other option as designed by app store 602. For example, selecting “Details” option 610 may allow the user to read a description 616 of event notice app 600 and see screen captures from event notice app 600. Selecting “Reviews” option 612 may allow the user to write and/or read reviews from other users of event notice app 600. Selecting “Related” option 614 may allow the user to view other client apps with similar content and/or produced by similar developers.

FIG. 7 shows an example embodiment of a mobile device home screen 702 including an event notice app icon 704. Event notice app icon 704 includes a notification indicator 706. Notification indicator 706 is configured to alert the user that there are new and/or unread matching occurrence(s) available on event notice app 600 (shown in FIG. 6). The user may select event notice app icon 704 from mobile device home screen 702 to access event notice app 600.

FIG. 8 shows an example embodiment of an event notice app user interface (UI) 800 displaying a start screen 802. Start screen 802 is displayed to the user when the user first accesses event notice app 600 (shown in FIG. 6). The user may select an E-Mail Sign-Up option 804 or a Social Network Sign-Up option 806. The particular sign-up option 804, 806 the user selects defines which user contact names—email or social network—that event notice app 600 may retrieve.

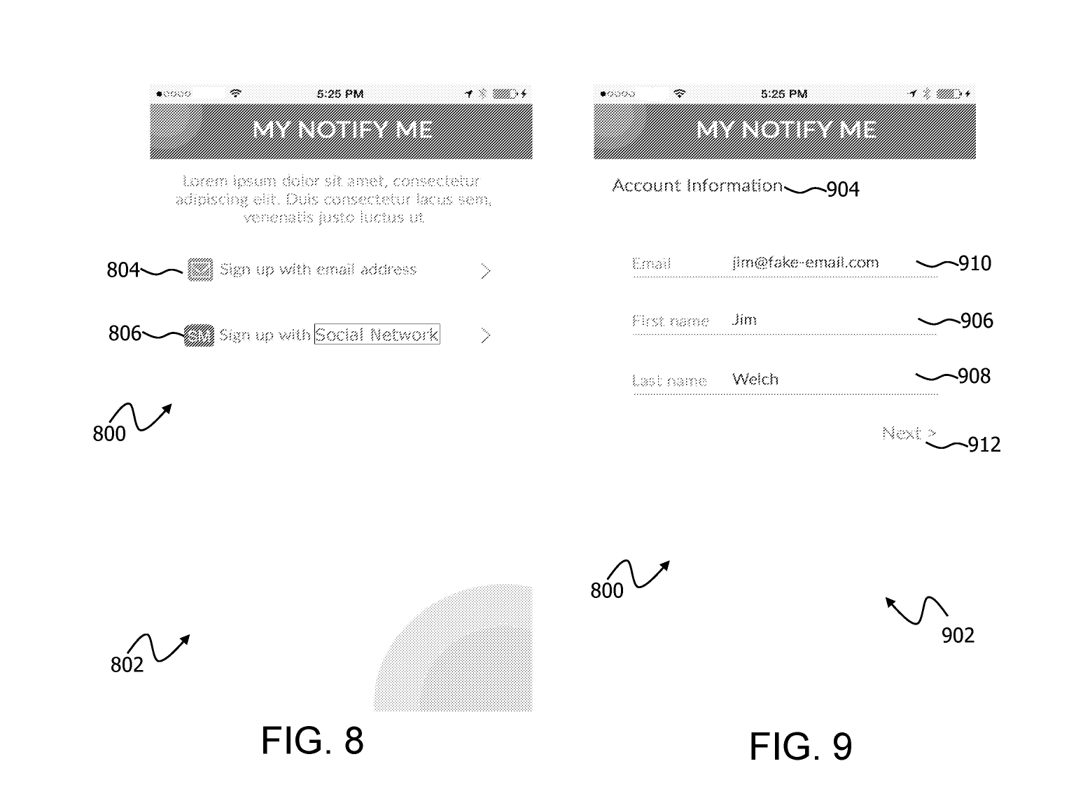

FIG. 9 shows an example embodiment of an event notice app UI (e.g., UI 800) displaying a sign-up screen 902. Sign-up screen 902 may be displayed, for example, if the user selects E-Mail Sign-Up option 804 (shown in FIG. 8). The user may be prompted to enter account information 904. In the example embodiment, the person information includes a first name 906, a last name 908, and an email address 910. Email address 910 is the email account from which event notice app 600 (shown in FIG. 6) may retrieve user contact names and associated contact information. Once the user has entered account information 904, the user may select a “Proceed” or “Next” option 912 to proceed with the sign-up process.

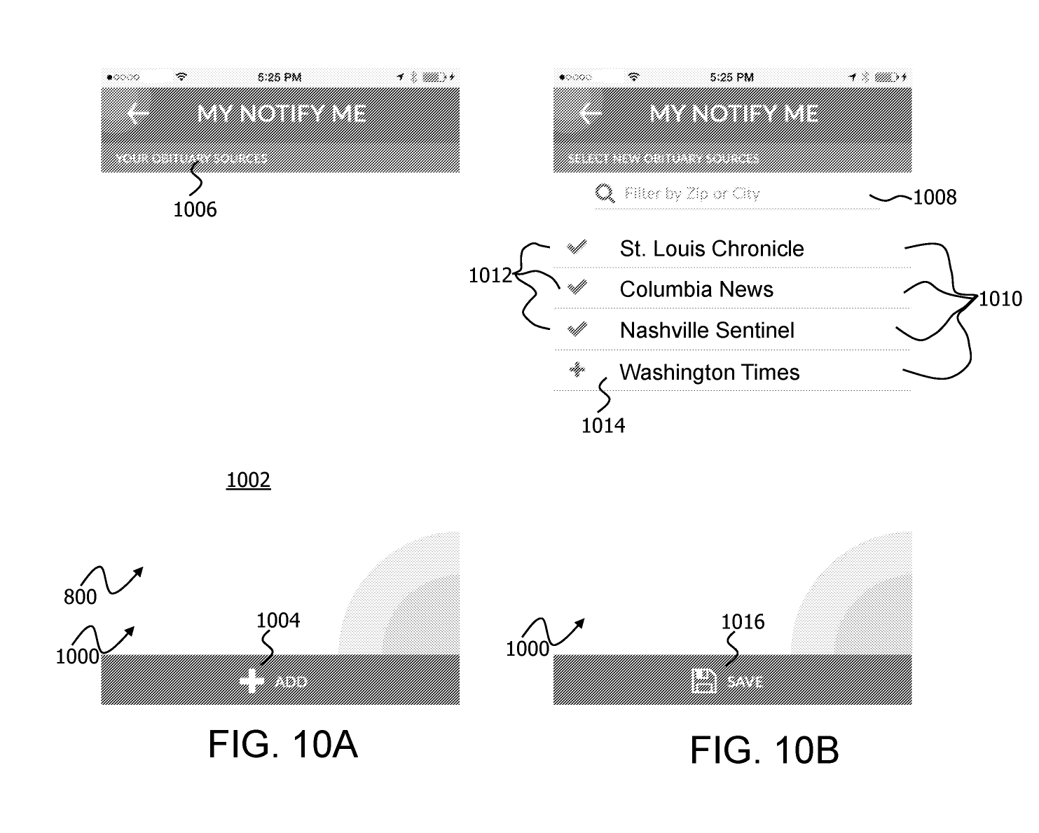

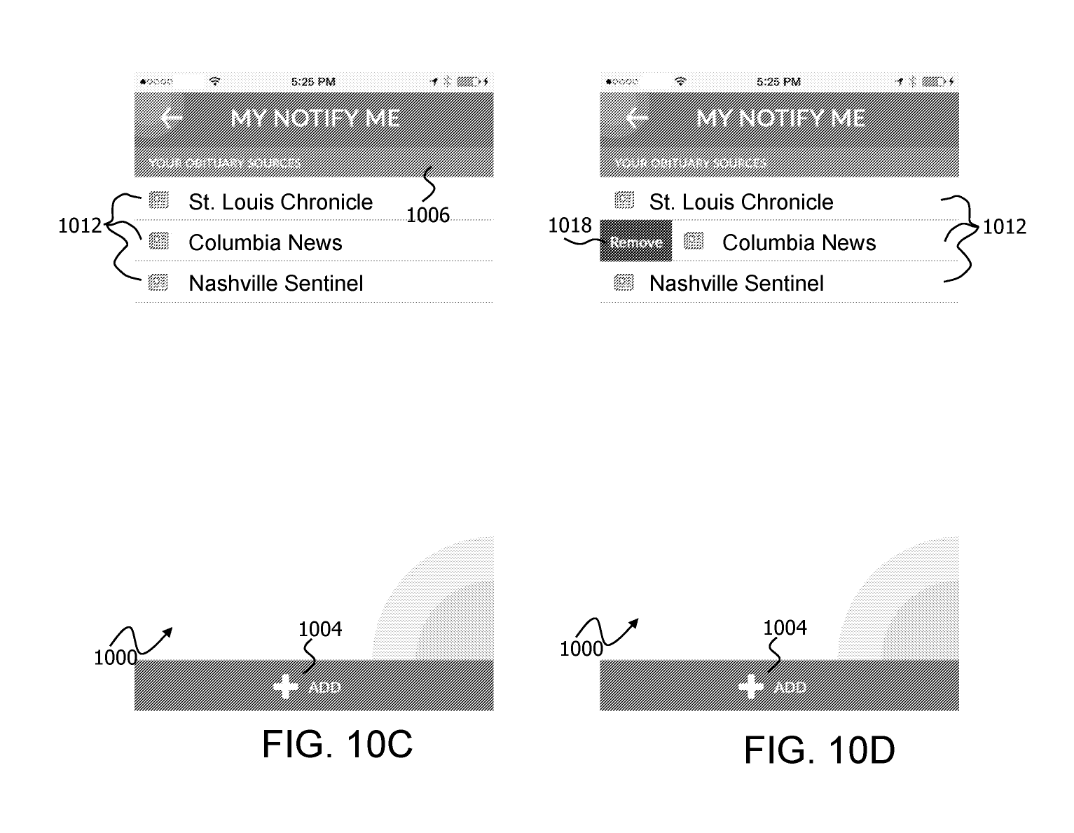

FIGS. 10A-10D show example embodiments of an event notice app UI (e.g., UI 800) displaying various selected publication screens 1000. FIG. 10A illustrates an example of an initial state 1002 of selected publication screen 1000, in which there are no selected publications. The user may select an “Add” option 1004 to add a publication to a list 1006 of selected publications. FIG. 10B illustrates an example of selected publication screen 1000 that results after the user selects “Add” option 1004 (shown in FIG. 10A). The user may use publication filter 1008 to find publications 1010 that the user would like the event notice app 600 (shown in FIG. 6) to search. For example, the user may select at least one publication 1010 from his or her hometown, his or her city of current residence, a city in which the user spent significant time, or a city in which the user has at least one contact. In the example embodiment, selected publication screen 1000 displays selected publications 1012 chosen by the user and a non-selected publication 1014. Once the user has found and selected at least one selected publication 1012, the user may select a “Save” option 1016 to save and store selected publications 1012. Database 106 (shown in FIG. 1) may be configured to store list 1006 of selected publications 1012. In some embodiments, list 1006 of selected publications 1012 includes the names of selected publications 1012. As described above, notification server 104 may use selected publications 1012 to filter received event data in which notification server 104 will search for matching occurrence(s) of user contact name(s).

FIG. 10C illustrates an example of selected publication screen 1000 with saved selected publications 1012. The user may again select “Add” option 1004 if the user would like to add more selected publications 1012. FIG. 10D illustrates how the user may further his or her selected publications 1012. The user may select (e.g., click or touch) one of selected publications 1012. In response to such a selection, event notice app 600 may display a “Remove” option 1018. Upon selection of “Remove” option 1018 by the user, the selected publication 1012 will be removed from list 1006 of selected publications 1012.

FIG. 11 shows an example embodiment of a mobile device UI 1100 displaying a contact retrieval authorization dialog box 1102. Dialog box 1102 may be presented to the user during the sign-up process. The user may choose “OK” 1104 to approve the contact retrieval by event notice app 600 (shown in FIG. 6) or choose “Don't Allow” 1106 to deny the contact retrieval. Upon approval, event notice app 600 (and, thereby, notification server 104, shown in FIG. 1) is authorized to access and retrieve user contact names and associated contact information from at least one of the user's mobile device, email account, and social network account. In some embodiments, notification server 104 may use additional contact information (e.g., first name, family member information, address) to improve its searching for matching occurrences. For example, notification server 104 may user the additional contact information to narrow down matching occurrences to those matching occurrences most likely to be relevant to the user. Notification server 104 may additionally or alternatively use additional contact information to verify or confirm that a matching occurrence of the user contact name is associated with the user's contact. For example, notification server 104 may use additional contact information to verify that an obituary containing the user contact (last) name “Jones” is, in fact, associated with “Michael Jones,” a contact of the user. Another announcement including the name “Sally Jones” then may not be associated with contact “Michael Jones,” in which case the announcement would not be displayed to the user. Database 106 (shown in FIG. 1) may be configured to store user contact name(s) and/or associated additional contact information.

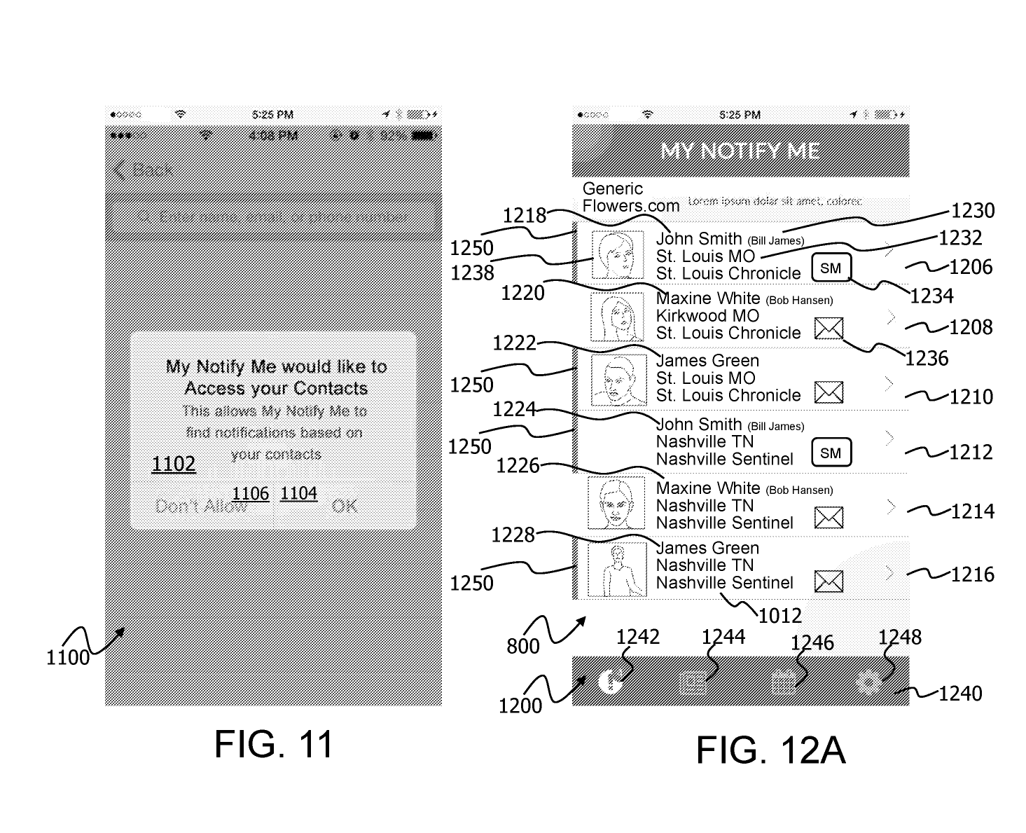

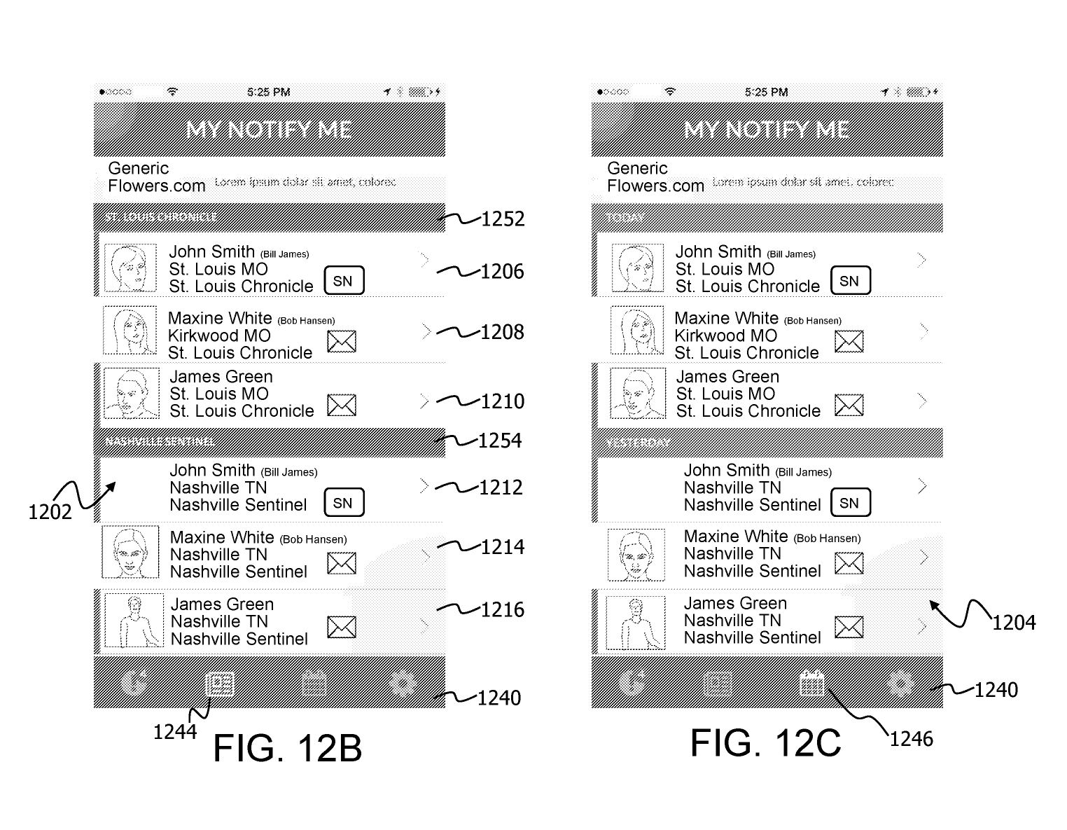

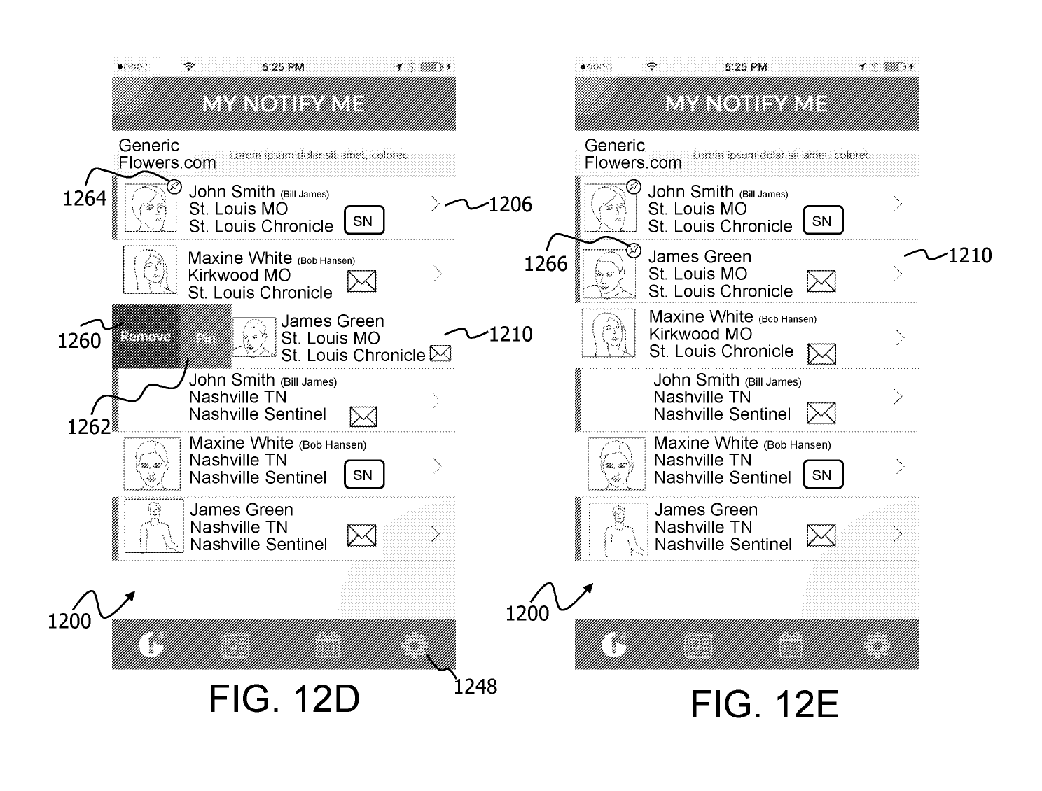

FIGS. 12A-12E show example embodiments of an event notice app UI displaying various search result screens 1200, 1202, 1204. Search result screen 1200 may, in some embodiments, be a “home screen” 1200 of event notice app 600 (shown in FIG. 6) and be displayed directly upon opening of event notice app 600. In other embodiments, search result screen 1200, 1202, 1204 may require further selection of a particular option (e.g., a button) in order to be displayed. Search result screens 1200, 1202, 1204 display the results of searching by notification server 104 (shown in FIG. 1), i.e., the matching occurrences. In the example embodiment, home screen 1200 includes search results 1206, 1208, 1210, 1212, 1214, and 1216. Search results 1206, 1208, 1210, 1212, 1214, and 1216 are transmitted to event notice app 600 by the notification server 104 (shown in FIG. 1) for display to the user. Search results 1206, 1208, 1210, 1212, 1214, and 1216 each include a portion of the event data in which a matching occurrence of a user contact name was found by notification server 104.

Each search result 1206, 1208, 1210, 1212, 1214, and 1216 includes a subject 1218, 1220, 1222, 1224, 1226, and 1228, respectively, of search result 1206, 1208, 1210, 1212, 1214, and 1216. The subject of the search result may contain a user contact name, as in search result subjects 1222 and 1228 of search results 1210 and 1216, respectively. In search result 1210 and 1216, for example, subject 1222 and 1228 of the search result does include a user contact name. In these examples, the last name of the subject (1222 and 1228) is a user contact name “Green.” In other cases, the subject of the search result may not include a user contact name, but the search result may contain matching occurrence of the user contact name within the text and/or content of the search result. In these cases, as in search result 1206, 1208, 1212, and 1214, the associated contact whose user contact name was found may be listed beside or otherwise proximate to the subject 1218, 1220, 1224, 1226, and 1228 of the search result. For example, in search result 1206, subject 1218 does not include a user contact name of any of the user's contacts. An associated contact 1230, shown here as “Bill James,” indicates a user contact name for associated contact 1230 (e.g., last name “James”) was found in the text/content of search result 1206.

A search result may also include a location of the subject of the search result (e.g., location 1232 of search result 1206), a selected publication associated with the matching occurrence (e.g., selected publication 1012 of search result 1216), and a contact source (e.g., contact source 1234 of search result 1206 and contact source 1236 of search result 1208). Contact source 1234, 1236 may be an icon that indicates whether the subject of the search result and/or the associated contact is an email contact (contact source 1236) or a social network contact (contact source 1234). A search result may also include a photo or image or the subject of the search result (e.g., image 1238 of search result 1206).

In the example embodiment, home screen 1200 includes a menu of options 1240, including, for example, Notifications 1242, Sort by Publication 1244, Sort by Date 1246, and Settings 1248. Notifications option 1242 is shown highlighted to indicate that the user is on a screen that displays the notifications. The notifications may indicate that the user has new and/or unread search results. In the example embodiment, each new and/or unread search result is denoted by an unread indicator 1250. The user may select the Sort by Publication option 1244 to sort/filter the displayed search results according to which selected publication with which the matching occurrence(s) are associated. The user may select the Sort by Date 1246 option to sort/filter the search results by the date on which event notice app 600 received the search result(s). The user may select the Settings option 1248 to adjust various settings related to event notice app 600, including editing his or her selected publications 1012 (as shown in FIGS. 10A-10D) and adding contacts and/or accounts from which to retrieve contacts.

Referring now to FIG. 12B, the user has selected the Sort by Publication option 1244, which is now shown highlighted in the menu of options 1240. The search results are now sorted based on which selected publication 1012 with which each matching occurrence is associated (e.g., in which selected publication the matching occurrence appeared). For example, matching occurrences in search results 1206, 1208, and 1210 appeared in selected publication 1252. Matching occurrences in search results 1212, 1214, and 1216 appeared in selected publication 1254.

Referring now to FIG. 12C, the user has selected the Sort by Date option 1246, which is now shown highlighted in the menu of options 1240. The search results are now sorted based on the date on which event notice app 600 received each search result. The search results may be sorted based on the date on which the matching occurrence was published in the associated selected publication 1012.

Referring now to FIGS. 12D and 12E, the user has returned to the home screen 1200. The user may find some search results important to him or her. The user may wish to re-read or otherwise interact again with a particular search result. The user may select the particular search result 1210. Upon such a selection, event notice app 600 may display a number of actions. In the example embodiment, event notice app 600 has displayed a “Remove” action 1260 and a “Pin” action 1262. The user may select “Pin” action 1262 to keep search result 1210 on his or her home screen 1200. Home screen 1200 shows pinned indicator 1264 on search result 1206, which indicates the user has already pinned search result 1206 by selecting search result 1206 and selecting “Pin” action 1262. FIG. 12E displays a new pinned indicator 1266 on search result 1210, and search result 1210 has been shifted upwards in the list of search results.

If the user does not find search result 1210 important or relevant, the user may select “Remove” action 1260 to immediately remove search result 1210 from the user's home screen 1200. Alternatively, the user may select neither “Pin” action 1262 nor “Remove” action 1260, and after a certain period of time, search result 1210 will “age out.” The period of time before which a search result will “age out” and be removed from the user's home screen 1200 may be automatically set and/or may be adjusted by the user using the “Settings” menu option.

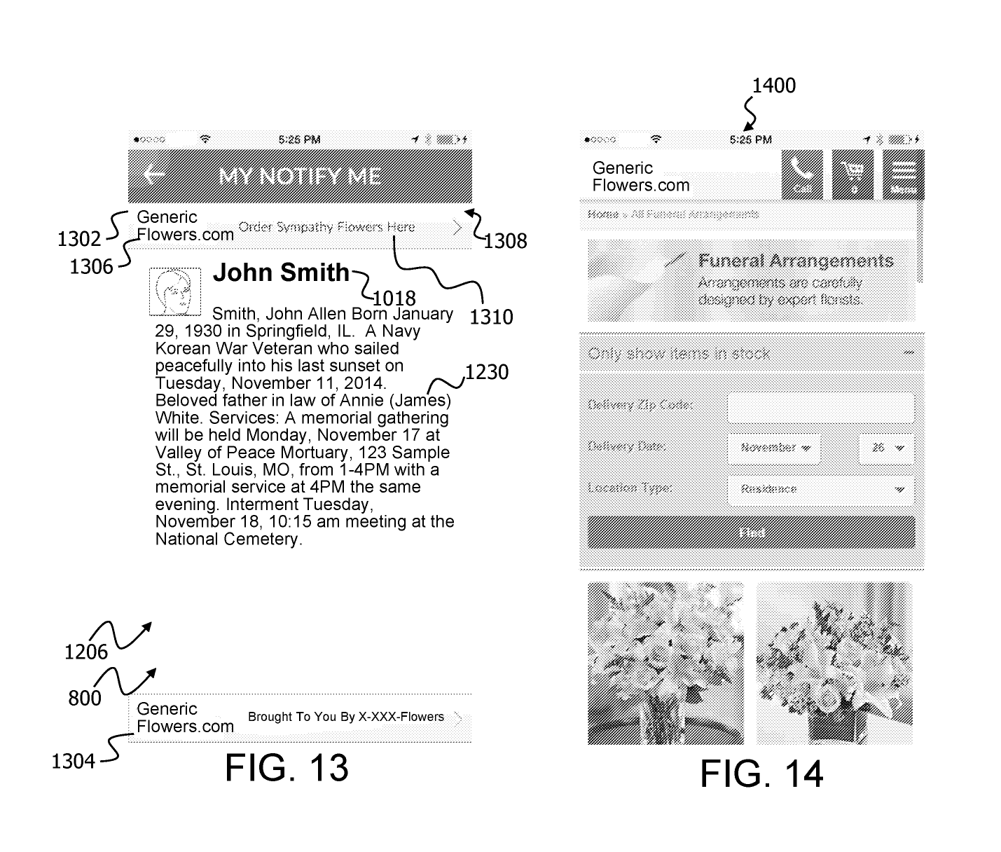

FIG. 13 shows an example embodiment of an event notice app UI 800 displaying a particular search result 1206 (shown in FIG. 12A). Search result 1206 includes subject 1218 of the matching occurrence (shown in FIG. 12A), as well as the text and content surrounding matching occurrence of the associated contact 1230 (shown in FIG. 12A) of the user. In the example embodiment, search result 1206 is an obituary. Search result 1206 was sent to event notice app 600 (shown in FIG. 6) for display to the user because of the matching occurrence of “James” present in the obituary, which is the user contact name of “Bill James”, associated contact 1230 in this example. If the user knows “Annie (James) White,” the user may know subject John Smith. As discussed above, the user may then choose to “pin” search result 1206. If the user does not know “Annie (James) White,” the user may choose to “remove” search result 1206.

Search result 1206 also includes at least one advertising space 1302, 1304, which may be purchased by an advertiser 1306. In the example embodiment, advertiser 1306 (also referred to herein as “linked advertiser 1306”) is GenericFlowers.Com. Advertising space 1302 includes an ad 1308. Ad 1308 may be delivered based on the content of search result 1206. In the example embodiment, ad 1308 includes a link 1310 for the user to order sympathy flowers. The user may select link 1310 and may be directed to a website or app associated with linked advertiser 1306.

In some embodiments, search result 1206 may alternatively or additionally include purchasing space (not shown in FIG. 13). “Purchasing space” is used herein to refer generally to a section of a search result (e.g., search result 1206) that displays products or services available for the user to purchase without leaving the event notice app UI. For example, the purchasing space may include a particular floral arrangement and/or card selection. As another example, if the event is a birth, the purchasing space may include gifts or floral arrangements suitable to congratulate the user's contact on the birth. The user may select one or more displayed product(s) to purchase. Event notice app 600 may prompt the user to enter various personal information, including payment information and shipping address. In these embodiments, the user is not directed to a third party to make a purchase, which may improve the convenience of event notice app 600. Generally, advertising and/or purchasing space may be referred to as “online content.” The online content allows the user to view product(s) available for purchase. The product(s) may be related to or associated with the life event that is included in the search result.

FIG. 14 shown an example embodiment of a linked advertiser app UI 1400, accessed through event notice app 600 (shown in FIG. 6). The linked advertiser app is associated with linked advertiser 1306 (shown in FIG. 13). The user may use the linked advertiser app UI 1400 (or a website associated with linked advertiser 1306) to purchase goods and/or services from linked advertiser 1306 that may be related to the content of search result 1206 (shown in FIG. 13). In the example embodiment, the user may use linked advertiser app UI 1400 to purchase flowers for the family of John Smith, the subject 1218 of the matching occurrence of search result 1206.

As will be appreciated based on the foregoing specification, the above-described embodiments of the disclosure may be implemented using computer programming or engineering techniques including computer software, firmware, hardware or any combination or subset thereof. Any such resulting program, having computer-readable code means, may be embodied or provided within one or more computer-readable media, thereby making a computer program product, i.e., an article of manufacture, according to the discussed embodiments of the disclosure. The computer-readable media may be, for example, but is not limited to, a fixed (hard) drive, diskette, optical disk, magnetic tape, semiconductor memory such as read-only memory (ROM), and/or any transmitting/receiving medium such as the Internet or other communication network or link. The article of manufacture containing the computer code may be made and/or used by executing the code directly from one medium, by copying the code from one medium to another medium, or by transmitting the code over a network.

This written description uses examples to disclose the embodiments, including the best mode, and also to enable any person skilled in the art to practice the embodiments, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A computer-implemented method for notifying a user of life events experienced by contacts of the user, the method implemented using a notification server in communication with a memory, the method comprising:
receiving, by the notification server, at least one user contact name, wherein each user contact name is retrieved from at least one of an email account, a social network account, and a mobile device associated with the user, and wherein each user contact name is associated with a user contact of the user;
receiving at least one selected publication from the user;
receiving event data, wherein the event data is associated with the at least one selected publication;
automatically searching, by the notification server, the event data for at least one matching occurrence of the at least one user contact name;
identifying a portion of the event data that includes a first matching occurrence of a first user contact name of the at least one user contact name, wherein the portion of event data includes a life event experienced by a first user contact associated with the first user contact name;
transmitting the portion of event data to the mobile device for display to the user within a user interface of an event notice app; and
transmitting online content to the mobile device for display to the user within the user interface of the event notice app, wherein the online content is associated with a product available for purchase by the user, the product being associated with the life event experienced by the first user contact.

2. The computer-implemented method of claim 1, wherein each user contact name includes contact information associated with the user contact name, and wherein receiving at least one user contact name further comprises requesting authorization from the user for access to the at least one user contact name.

3. The computer-implemented method of claim 2, further comprising:
analyzing the portion of the event data using the contact information for the first user contact name to confirm that the matching occurrence refers to the first user contact name; and
transmitting the portion of the event data to the mobile device for display to the user when the matching occurrence is confirmed.

4. The computer-implemented method of claim 1, wherein the online content includes at least one of an advertisement and a purchasing space, and wherein the method further comprises enabling purchase of the product by the user within the user interface of the event notice app.

5. The computer-implemented method of claim 4, further comprising:
receiving a purchase input from the user within the user interface of the event notice app; and
transmitting the purchase input to a vendor associated with the online content.

6. The computer-implemented method of claim 1, wherein the matching occurrence includes one of a partial match, a contextual match, a pattern match, or the result of a social graph analysis.

7. The computer-implemented method of claim 1, wherein transmitting the portion of event data to the mobile device further comprises transmitting a signal to the mobile device to activate a display feature, and cause to be displayed the event data to the user.

8. A computer-readable media having computer-executable instructions embodied thereon for notifying a user of life events experienced by contacts of the user, within a user interface of an event notice app, wherein when executed by a computer having at least one processor, the computer-executable instructions cause the processor to:
receive at least one user contact name, wherein each user contact name is retrieved from at least one of an email account, a social network account, and a mobile device associated with the user, and wherein each user contact name is associated with a user contact of the user;
receive at least one selected publication from the user;
receive event data, wherein the event data is associated with the at least one selected publication;
automatically search the event data for at least one matching occurrence of the at least one user contact name;
identify a portion of the event data that includes a first matching occurrence of a first user contact name of the at least one user contact name, wherein the portion of event data includes a life event experienced by a first user contact associated with the first user contact name;
transmit the portion of event data to the mobile device for display to the user; and
transmit online content to the mobile device for display to the user, wherein the online content is associated with a product available for purchase by the user, the product being associated with the life event experienced by the first user contact.

9. The computer-readable media of claim 8, wherein each user contact name includes contact information associated with the user contact name, and wherein the computer-executable instructions further cause the processor to request authorization from the user for access to the at least one user contact name.

10. The computer-readable media of claim 9, wherein the computer-executable instructions further cause the processor to:
analyze the portion of the event data using the contact information for the first user contact name to confirm that the matching occurrence refers to the first user contact name; and
transmit the portion of the event data to the mobile device when the matching occurrence is confirmed.

11. The computer-readable media of claim 8, wherein the online content includes at least one of an advertisement and a purchasing space, and wherein the online content enables purchase of the product by the user within the user interface of the event notice app.

12. The computer-readable media of claim 11, wherein the computer-executable instructions further cause the processor to:
receive a purchase input from the user within the user interface of the event notice app; and
transmit the purchase input to a vendor associated with the online content.

13. The computer-readable media of claim 8, wherein receiving event data comprises receiving the event data through an XML data feed.

14. The computer-readable media of claim 8, wherein the computer-executable instructions further cause the processor to transmit a signal to the mobile device to activate a display feature, and cause to be displayed the event data to the user.

15. An event notice computer system for notifying a user of life events experienced by contacts of the user, said event notice computer system comprising a notification server comprising a processor in communication with a memory, said processor programmed to:
receive at least one user contact name, wherein each user contact name is retrieved from at least one of an email account, a social network account, and a mobile device associated with the user, and wherein each user contact name is associated with a user contact of the user;
receive at least one selected publication from the user;
receive event data, wherein the event data is associated with the at least one selected publication;
automatically search the event data for at least one matching occurrence of the at least one user contact name;
identify a portion of the event data that includes a first matching occurrence of a first user contact name of the at least one user contact name, wherein the portion of event data includes a life event experienced by a first user contact associated with the first user contact name;
transmit the portion of event data to the mobile device for display to the user; and
transmit online content to the mobile device for display to the user, wherein the online content is associated with a product available for purchase by the user, the product being associated with the life event experienced by the first user contact.

16. The event notice computer system of claim 15, wherein each user contact name includes contact information associated with the user contact name, and wherein the computer-executable instructions further cause the processor to request authorization from the user for access to the at least one user contact name.

17. The event notice computer system of claim 15, wherein said processor is further programmed to:
analyze the portion of the event data using the contact information for the first user contact name to confirm that the matching occurrence refers to the first user contact name; and
transmit the portion of the event data to the mobile device when the matching occurrence is confirmed.

18. The event notice computer system of claim 15, wherein the online content includes at least one of an advertisement and a purchasing space, and wherein the online content enables purchase of the product by the user within the user interface of the event notice app.

19. The event notice computer system of claim 18, wherein said processor is further programmed to:
receive a purchase input from the user within the user interface of the event notice app; and
transmit the purchase input to a vendor associated with the online content.

20. The event notice computer system of claim 15, wherein said processor is further programmed to transmit a signal to the mobile device to activate a display feature, and cause to be displayed the event data to the user.
